(19) United States
(12) Patent Application Publication
(10) Pub. No.: US 2009/0017369 A1
(43) Pub. Date: Jan. 15, 2009

(54) Battery terminal connector, portable communicating devices with the connector and battery connecting method thereof

(75) Inventor: Hsien-Kuang Shih, Chang Hwa County (TW)

Correspondence Address: REED SMITH LLP, Suite 1400, 3110 Fairview Park Drive, Falls Church, VA, 22042, US

(73) Assignee: K.S. Terminals, Inc.

(21) Appl. No.: 11/907,592

(22) Filed: Oct. 15, 2007

(30) Foreign Application Priority Data
Jul. 13, 2007 (TW) 096125517

(51) Int. Cl. H01M 2/26

(52) U.S. Cl. 429/121; 439/754

(57) ABSTRACT

A battery terminal connector is disclosed in the invention, which is disposed in a battery slot of an electronic device, so as to induce electrical conduction via contacting a battery, and a structure of fool-proof is formed around the battery slot in order to guide users to insert the battery along a particular direction. The battery terminal connector comprises a basement of insulator body, a plurality of terminal sockets integrally extended from the basement of insulator body and protruded in parallel to each other, and a plurality of elastic terminals, and at least a portion of each of the elastic terminals extends out of each terminal socket. Moreover, the battery terminal connector is characterized in that at least an L-shaped buffering portion integrally molded with the basement of insulator body is formed between two neighboring terminal sockets, and the L-shaped buffering portion may be fixingly tilted under an external force, and an end of the L-shaped buffering portion facing the battery is formed into an contact head protruding outwardly. When no battery is inserted into the battery slot, the length of the contact head of the L-shaped buffering portion protruding outwards is greater than that of the elastic terminals extending out of the terminal sockets, so that when impacts are born upon the battery terminal connector from the battery, the impacts are firstly buffered by the contact head, thus reducing the impacts born upon each of the elastic terminals from the battery.

### FIELD OF THE INVENTION

The invention relates to a battery terminal connector, a terminal module, a portable communicating device containing the battery terminal connector or the terminal module, and a method for connecting a battery to the battery terminal connector or the terminal module, more particularly to a battery terminal connector, a terminal module, a portable communicating device having the battery terminal connector or the terminal module, and a method for connecting a battery to the battery terminal connector or the terminal module that may protect terminals therein from being directly impacted by incoming batteries when the batteries are not inserted via normal methods.

### DESCRIPTION OF PRIOR ART

It is common knowledge that to change batteries for cell phones, PDA, or other portable communicating devices, it is necessary to replace a used battery with a recharged battery from a battery slot of the portable communicating device, wherein the battery must be compatible with the specification of the battery slot. The battery slot usually has a single row or multiple rows of metal conductive terminals disposed therein, and each terminal is bent into a variety of shapes with a portion of its structure exposed. When the battery is inserted into the battery slot correctly, a conductive electrode of the battery is allowed to contact the exposed portion of the terminal, which subsequently induces electrical conduction.

However, users often insert the battery into the battery slot incorrectly due to carelessness or unfamiliarity with the portable communicating device during actual usage of the battery. Consequently, the exposed portion of the terminal is frequently bent and contorted from impacts and compression of the battery, which leads to short circuiting and compromises functions of the portable communicating device. Manufacturers of batteries have proposed many variations of the terminal in response to this problem, which includes changing the way the terminal is subjected to an external force, adjusting directions or mass of the external force, adjusting directions of the arms of force, or reducing height of the terminal, and two examples may be observed in FIGS. 1 and 2. However, the proposals are still limited by factors like contact points of the terminal and height of battery terminal connector, and do not seek to alter the terminal itself, which does not solve the original problem after all.

### SUMMARY OF THE INVENTION

In light of the aforesaid problems, this invention discloses a battery terminal connector, a terminal module, and a portable communicating device having the battery terminal connector or the terminal module. Using the battery terminal connector as an example for elucidating characteristics of the disclosure, the battery terminal connector is disposed in a battery slot of an electronic device, which induces electrical conduction via contacting the battery, and a structure of fool-proof is formed around the battery slot so as to guide the battery to be inserted along a particular direction into the battery slot. The battery terminal connector comprises a basement of insulator body, a plurality of terminal sockets integrally extended from the basement of insulator body and protruded in parallel to each other, and a plurality of elastic terminals, and at least a portion of each of the elastic terminals extends out of each terminal socket. Moreover, the battery terminal connector is characterized in that at least an L-shaped buffering portion integrally molded with the basement of insulator body is formed between two neighboring terminal sockets, and the L-shaped buffering portion may be fixingly tilted under an external force and an end of the L-shaped buffering portion facing the battery is formed into a contact head protruding outwardly. When no battery is inserted into the battery slot, the length of the contact head of the L-shaped buffering portion protruding outwards is greater than that of each elastic terminal extending out of each terminal socket. When the battery impacts on the battery terminal connector, the contact head may ease the impacts from the battery, thus lessening impacts born upon each of the elastic terminals from the battery.

Furthermore, this invention also discloses a method for connecting a battery to the battery terminal connector or the terminal module. As described previously, the battery terminal connector is disposed in the battery slot of the electronic device and induces electrical conduction via contacting the battery, wherein the battery terminal connector comprises a basement of insulator body, a plurality of terminal sockets, and a plurality of elastic terminals, and at least an L-shaped buffering portion integrally molded with the basement of insulator body is formed two neighboring terminal sockets, and an end of the L-shaped buffering portion facing the battery is formed into a contact head protruding outwardly.

The method for connecting a battery to the battery terminal connector comprises the following steps:
a. obliquely inserting a conductive side of the battery into the battery slot from an upper right hand side or an upper left hand side towards a side below;
b. continually inserting the battery into the battery slot obliquely until the battery runs into the contact head of the L-shaped buffering portion;
c. horizontally moving the battery, so that when the battery is obliquely inserted into the battery slot from the upper right hand side towards a side below, the battery pushes the contact head a side and comes into contact with the elastic terminal, whereas when the battery is obliquely inserted into the battery slot from the upper left hand side towards a side below, the L-shaped buffering portion tilts forwards due to impacts from the battery coming from the upper left hand side, thus preventing the elastic terminal from contacting the battery directly;
d. keeping moving the battery horizontally so as to allow the battery to keep pushing against the contact head and the elastic terminal, so that the L-shaped buffering portion is fixingly tilted towards a direction where the battery is moving into; and
e. stopping moving the battery once the battery is placed into the battery slot, so that the battery is retained via a reverse force of the L-shaped buffering portion, and the battery may come into contact with the elastic terminal stably.

Therefore, the primary objective of the invention is to propose a battery terminal connector that prevents the terminals from directly bearing impacts resulted from inserting the battery into the battery slot, thus protecting the terminals from being damaged.

Another objective of the invention is to propose a terminal module that prevents the terminals from directly bearing impacts resulted from inserting the battery into the battery slot, thus protecting the terminals from being damaged.

Still another objective of the invention is to propose a portable communicating device that prevents the terminals from directly bearing impacts resulted from inserting the battery into the battery slot, thus protecting the terminals from being damaged.

A further objective of the invention is to propose a method for connecting the battery to the battery terminal connector that prevents the terminals from directly bearing impacts resulted from inserting the battery into the battery slot, thus protecting the terminals from being damaged.

A further objective of the invention is to propose a method for connecting the battery to the terminal module that prevents the terminals from directly bearing impacts resulted from inserting the battery into the battery slot, thus protecting the terminals from being damaged.

A further objective of the invention is to propose a battery terminal connector that has a basement of insulator body for providing a fool-proof structure and buffering, so that the terminals are protected from direct compression and impacts of the battery when the battery is inserted into the battery slot incorrectly.

A further objective of the invention is to propose a terminal module that has a basement of insulator body for providing a fool-proof structure and buffering, so that the terminals are protected from direct compression and impacts of the battery when the battery is inserted into the battery slot incorrectly.

A further objective of the invention is to propose a portable communicating device that has a basement of insulator body for providing a fool-proof structure and buffering, so that the terminals are protected from direct compression and impacts of the battery when the battery is inserted into the battery slot incorrectly.

A further objective of the invention is to propose a method for connecting the battery to the battery terminal connector that has a basement of insulator body for providing a fool-proof structure and buffering, so that the terminals are protected from direct compression and impacts of the battery when the battery is inserted into the battery slot incorrectly.

A further objective of the invention is to propose a method for connecting the battery to the terminal module that has a basement of insulator body for providing a fool-proof structure and buffering, so that the terminals are protected from direct compression and impacts of the battery when the battery is inserted into the battery slot incorrectly.

### BRIEF DESCRIPTION OF DRAWINGS

The structure and the technical means adopted by the present invention to achieve the above and other objectives can be best understood by referring to the following detailed description of the preferred embodiments and the accompanying diagrams, wherein:

FIG. 1 is a dissected view that shows a conventional battery terminal connector and a comparison of contortion of a guiding corner in the terminal before and after the battery terminal connector is compressed by a battery;

FIG. 2 is a dissected view that shows a conventional battery terminal connector and a comparison of compression of the terminal before and after the battery terminal connector is compressed by a battery;

FIG. 3 is a three-dimensional view that shows a battery terminal connector and an enlarged view for a part of structure thereof according to the first preferred embodiment of the invention;

FIG. 4 is a three-dimensional view that shows a basement of insulator body and an L-shaped buffering portion integrally molded thereon in the battery terminal connector according to the first preferred embodiment of the invention;

FIGS. 5A to 5C are dissected views that show how the L-shaped buffering portion tilt in accordance with external forces from a battery in the battery terminal connector according to the first preferred embodiment of the invention;

FIG. 6 is a partial view that shows the battery terminal connector according to another preferred embodiment of the invention;

FIGS. 7A to 7E are dissected views that show how a battery is assembled with a battery terminal connector or a terminal module according to a fourth preferred embodiment of the invention;

FIGS. 8A and 8B are dissected views that show how a battery is assembled with a battery terminal connector or a terminal module according to a fifth preferred embodiment of the invention.

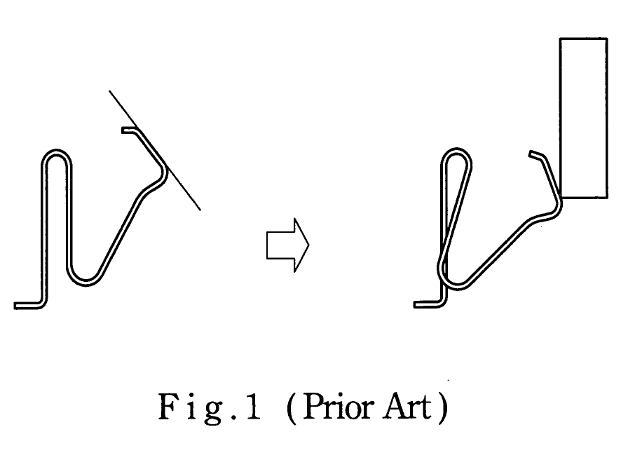

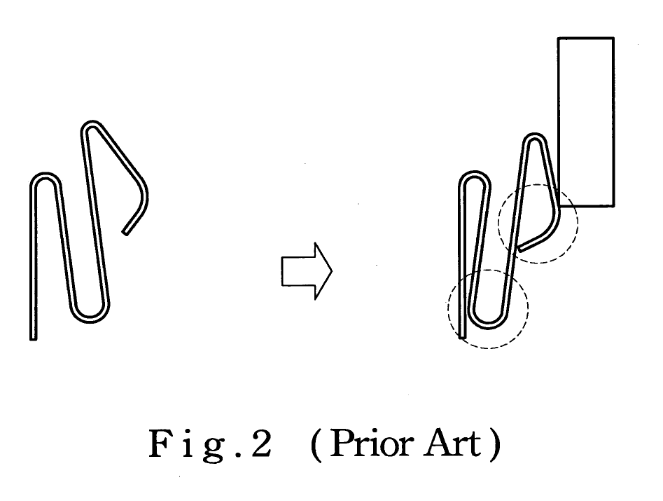

### DETAILED DESCRIPTION OF PREFERRED EMBODIMENTS

The present invention discloses a battery terminal connector, a terminal module, a portable communicating device having the battery terminal connector or the terminal module, which may protect terminals from being directly impacted by incoming batteries when the batteries are not inserted via normal methods, as well as a method for connecting a battery to the battery terminal connector or the terminal module.

The principles of mechanics and the basic structures of conductive terminals may be easily comprehended by those of ordinary skill in the relevant prior arts, and thus will not be further described hereafter. Meanwhile, it should be noted that the drawings referred to in the following paragraphs only serve the purpose of illustrating structures related to the characteristics of the disclosure, and are not necessarily drawn according to the actual sizes of the object of the disclosure.

### The First Preferred Embodiment

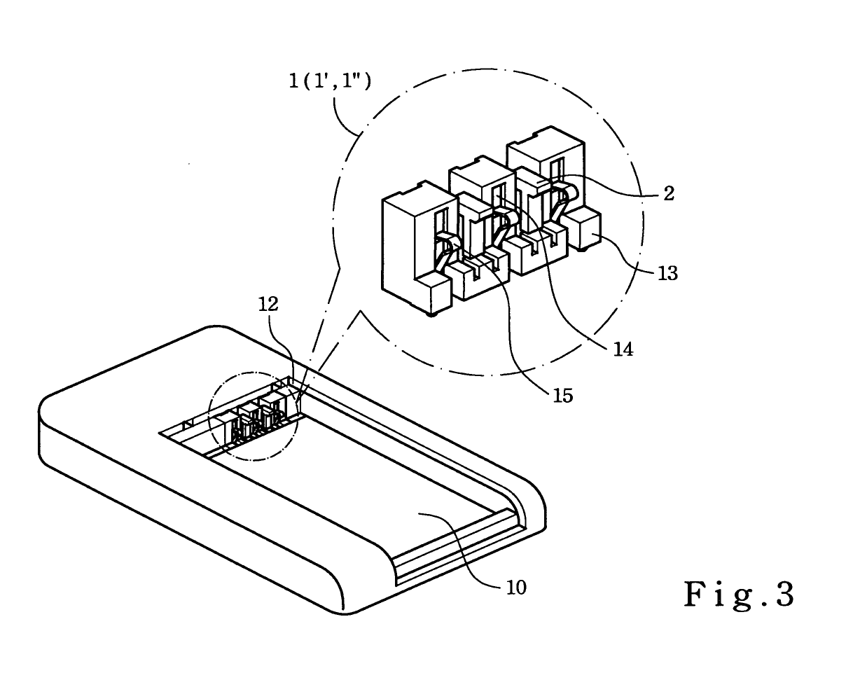

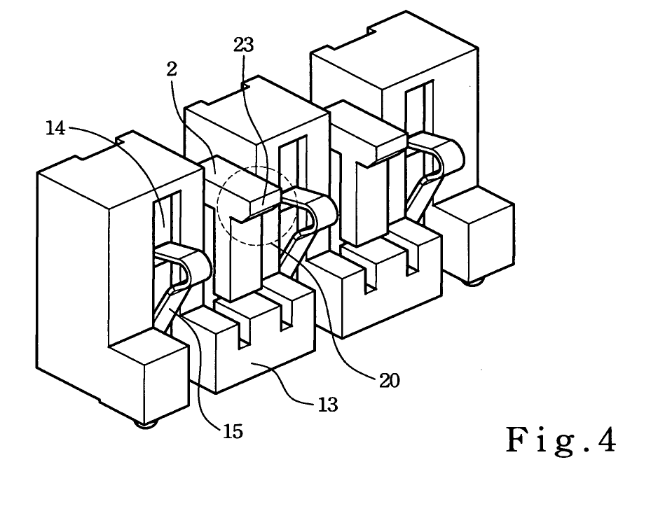

FIGS. 3 and 4 are three-dimensional and partially blown-up views that show a battery terminal connector according to the first preferred embodiment of the invention. It may be observed from the drawings that a battery terminal connector 1 is disposed in a battery slot 10 of electronic devices such as cell phones, Personal Digital Assistants (PDA), MP3 players, BlackBerry smartphones, and handheld computers, so as to be used in combination with a compatible battery and induce electrical conduction. A structure of fool-proof 12 is formed around the battery slot 10 (for example, forming retaining plates around the battery slot or concave indentations and protrusions at corners of battery housing), so as to guide users to insert the battery along a particular direction into the batter slot 10. Referring to FIG. 3, the battery terminal connector 1 comprises a basement of insulator body 13, a plurality of terminal sockets 14 integrally extended from the basement of insulator body 13 and protruded in parallel to each other, and a plurality of elastic terminals 15. At least a portion of each of the elastic terminals 15 extends out of each terminal socket 14. Referring to FIG. 4, moreover, the battery terminal connector 1 of the first preferred embodiment of the invention is characterized in that at least an L-shaped buffering portion 2 integrally molded with the basement of insulator body 13 is formed between two neighboring terminal sockets 14, and an end of the L-shaped buffering portion 2 facing the battery is formed into a contact head 20 protruding outwardly. When no battery is inserted into the battery slot 10, a length of the contact head 20 of the L-shaped buffering portion 2 protruding outwards is greater than that of each elastic terminal 15 extending out of each terminal socket 14.

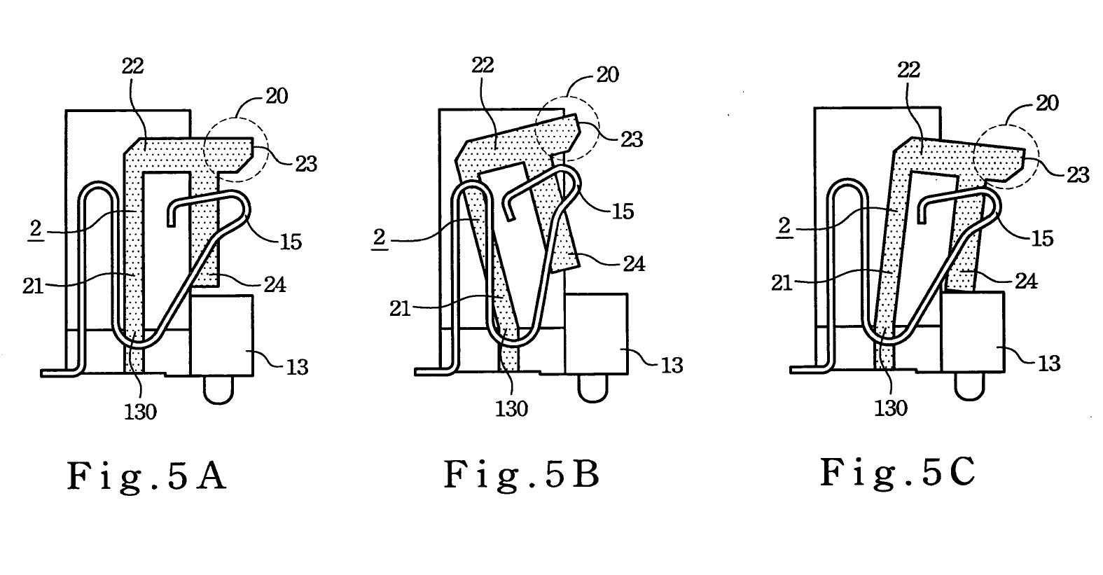

Referring to FIG. 5, the L-shaped buffering portion 2 further comprises an integrally formed vertical part 21 and an integrally formed horizontal part 22, and the vertical part 21 extends upwards from the basement of insulator body 13. A length of a part of the L-shaped buffering portion 2 that protrudes out of the basement of insulator body 13 is smaller than a thickness of the battery, and the L-shaped buffering portion 2 has a fulcrum 130 formed at an end thereof near the basement of insulator body 13. On the other hand, the horizontal part 22 extends horizontally from an end of the vertical part 21 away from the fulcrum 130, and the horizontal part 22 extends out of the terminal socket (not shown) and connects to the contact head 20. The contact head 20 tapers gradually from bottom to top, and a front end of the contact head 20 that contacts the battery has a blocking plane 23 formed thereon for guiding the L-shaped buffering portion 2 to tilt away from the contact head 20. The blocking plane 23 may be trapezoid or circular in cross section. The horizontal part 22 outwardly extends towards a direction opposite to that for inserting the battery, and the horizontal part 22 has an interfering stick 24 integrally and downwardly extended from a bottom part thereof near the contact head 20, wherein the height of the interfering stick 24 is smaller than the vertical length of the vertical part 21, and the height of the interfering stick 24 is determined by predetermined degrees at which the horizontal part 22 is tilted towards a lower side of the battery, and the smaller the predetermined degrees at which the horizontal part 22 is tilted towards the battery, the greater the height of the interfering stick 24.

The L-shaped buffering portion 2 and the basement of insulator body 13 are often integrally formed via the method of injection molding. Still referring to FIG. 5, the L-shaped buffering portion 2 should be made from stiff materials that are slightly flexible, and the preferable materials are elastic plastics, expandable metals, flexible metal alloys, and elastic insulating resins. In addition to the aforesaid materials, the uses of any stiff materials that are slightly flexible are within the scope of this invention, such as rubber and hardened resins.

Because the vertical part 21 of the L-shaped buffering portion 2 is made from stiff materials that are slightly flexible, when the L-shaped buffering portion 2 is impacted by a battery, the L-shaped buffering portion 2 tilts according to directions of the impact force with the fulcrum 130 as its pivot point. When no battery is inserted into the battery slot 10, the length of the contact head 20 of the L-shaped buffering portion 2 protruding outwards is greater than that of the elastic terminal 15 extending out of the terminal socket 14. Therefore, when impacts are born upon the battery terminal connector 1, the contact head 20 may bear and ease the direct impacts from the battery, thus lessening impacts born upon each of the elastic terminals 15, and protecting the elastic terminals 15 from being damaged.

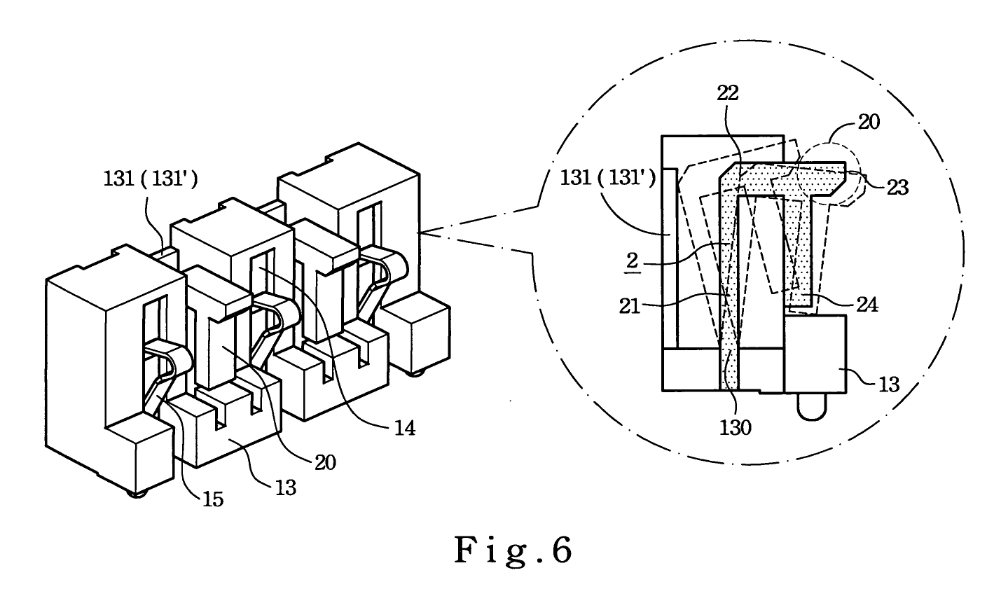

Moreover, to enhance contacts between conductive parts of the battery and exposed terminals of the battery terminal connector, a variation of the first preferred embodiment of the invention is also disclosed here. Referring to FIG. 6, the battery terminal connector (also referring to the battery terminal connector 1 in FIG. 3) has a continuous or discontinuous block wall 131, or one or a plurality of block strips 131′ integrally formed with the basement of insulator body 13 and between two neighboring terminal sockets 14, which are also a distance away from the battery. The thickness of the block wall 131 or the block strip 131′ is determined by precise calculations, and may provide a reverse force that compensates for the tilting of the vertical part 21, so as to prevent the L-shaped buffering portion 2 from tilting excessively. Therefore, the distance which the elastic terminal 15 is pushed away by the battery may be controlled, which effectively protects the elastic terminal 15 from being pushed excessively and damaged, as well as preventing the L-shaped buffering portion 2 from tilting backwards excessively and consequently fracturing the vertical part 21.

### The Second Preferred Embodiment

A terminal module is disclosed in the second preferred embodiment of the invention, and the terminal module may complement the batteries of digital and electronic products in order to induce electrical conduction. The components and overall structure of the terminal module are mostly similar to the subject of the first preferred embodiment, and thus details that have been mentioned in the previous embodiment will not be further described hereafter, and only characteristics of this embodiment that are different from that of the previous embodiment are emphasized below.

Referring to FIGS. 3 to 6, the terminal module 1′ comprises a basement of insulator body 13, a plurality of terminal sockets 14 integrally extended from the basement of insulator body 13 and protruded in parallel to each other, and a plurality of elastic terminals 15. At least a portion of each of the elastic terminals 15 extends out of each terminal socket 14. At least an L-shaped buffering portion 2 integrally molded with the basement of insulator body 13 is formed between two neighboring terminal sockets 14, and the L-shaped buffering portion 2 may be fixingly tilted under an external force, and an end of the L-shaped buffering portion 2 facing the battery is formed into a contact head 20 protruding outwardly. When the battery has not impacted on the terminal module 1′, the length of the contact head 20 of the L-shaped buffering portion 2 protruding outwards is greater than that of each elastic terminal 15 extending out of each terminal socket 14. When the battery has impacted on the terminal module 1′, the battery comes into contact with the contact head 20 firstly, which acts as a buffer that lessens the impacts from the battery upon the elastic terminals 15.

### The Third Preferred Embodiment

A portable communicating device 1″ having the aforesaid battery terminal connector or the aforesaid terminal module is disclosed in the third preferred embodiment of the invention, the portable communicating device 1″ may be a cell phone, a Personal Digital Assistant (PDA), an MP3 player, a BlackBerry smartphone, or a handheld computer. The components and overall structures of the battery terminal connector 1 and the terminal module 1′ are mostly similar to the subject of the first preferred embodiment, and thus details that have been mentioned in the previous embodiment will not be further described hereafter, and only characteristics of this embodiment that are different from that of the previous embodiments are emphasized below.

The portable communicating device 1″ comprises a processor, a circuit board, and a housing (all of which are of prior arts and not shown here). The portable communicating device 1″ has a battery slot 10 for receiving a battery formed on the housing, and a structure of fool-proof 12 is formed around the battery slot 10 for guiding the battery to be inserted along a particular direction into the battery slot 10, and the battery slot 10 has at least a row of terminal module 1′ formed therein so as to induce electrical conduction from contacting the battery. As indicated in FIGS. 3 to 6, the terminal module 1′ comprises a basement of insulator body 13, a plurality of terminal sockets 14 integrally extended from the basement of insulator body 13 and protruded in parallel to each other, and a plurality of elastic terminals 15. At least a portion of each of the elastic terminals 15 extends out of each terminal socket 14. It may be seen in FIG. 4 that at least an L-shaped buffering portion 2 integrally molded with the basement of insulator body 13 is formed between two neighboring terminal sockets 14, and the L-shaped buffering portion 2 may be fixingly tilted under an external force, and an end of the L-shaped buffering portion 2 facing the battery is formed into a contact head 20 protruding outwardly. When no battery is inserted in the battery slot 10, the length of the contact head 20 of the L-shaped buffering portion 2 protruding outwards is significantly greater than that of each elastic terminal 15 extending out of each terminal socket 14, so that when the battery has impacted on the terminal module 1′, the battery comes into contact with the contact head 20 firstly, which acts as a buffer that lessens the impacts from the battery upon the elastic terminals 15.

### The Fourth Preferred Embodiment

A method for connecting a battery to the battery terminal connector or the terminal module is also disclosed in this invention. The method is related to a process of inserting the battery into the battery slot, in which the battery firstly impacts on the L-shaped buffering portion and the elastic terminals subsequently, and then makes the L-shaped buffering portion tilt on the same spot. The components and overall structures of the battery terminal connector and the terminal module are mostly similar to the subject of the first preferred embodiment, and thus details that have been mentioned in the previous embodiment will not be further described hereafter.

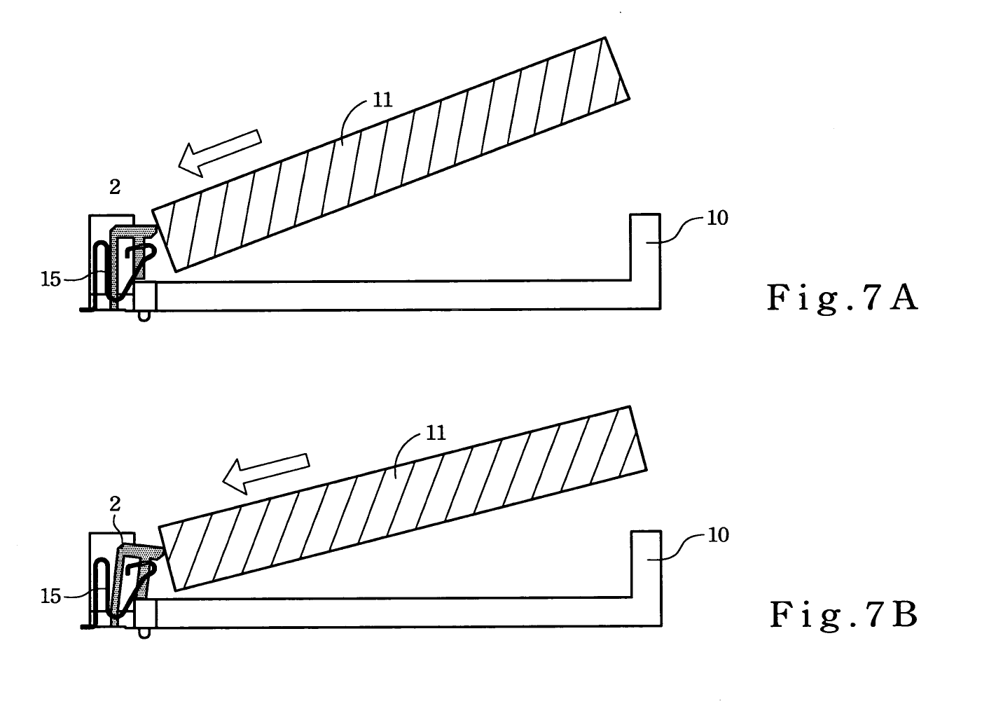

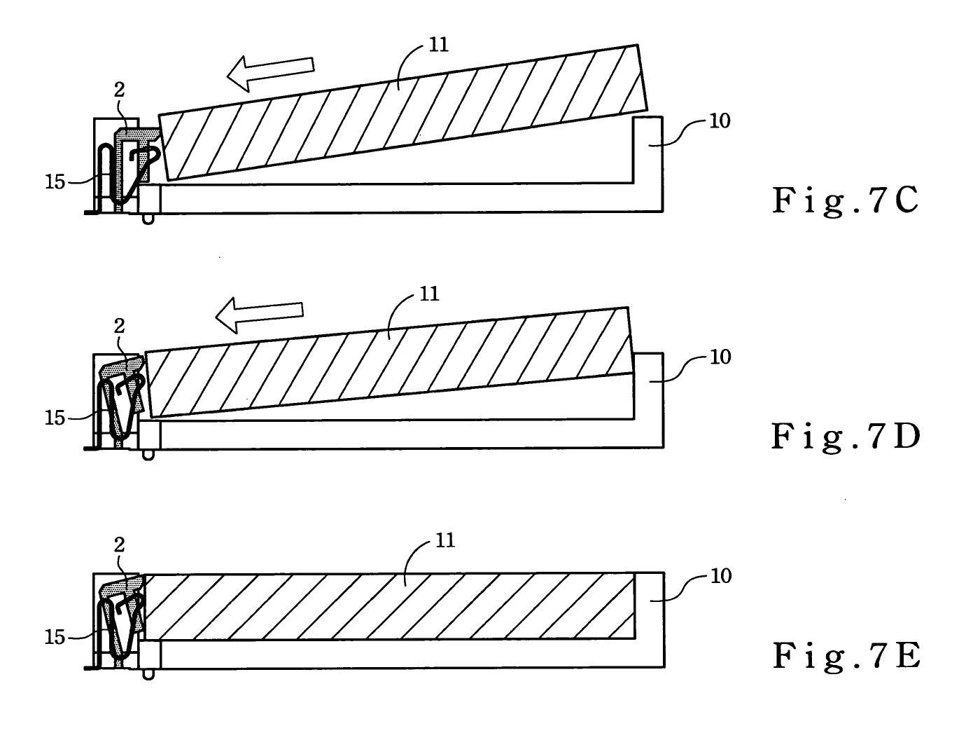

The connecting of the battery to the battery terminal connector or the terminal module is achieved via controlling a distance in the contact between the battery and the battery terminal connector or the terminal module, as well as via controlling impacts on the terminals resulted from the battery. Referring to FIGS. 6 and 7, the battery terminal connector 1 or the terminal module 1′ comprises a basement of insulator body 13, a plurality of terminal sockets 14, and a plurality of elastic terminals 15. At least an L-shaped buffering portion 2 integrally molded with the basement of insulator body 13 is formed between two neighboring terminal sockets 14, and an end of the L-shaped buffering portion 2 facing the battery is formed into a contact head 20 protruding outwardly. The components and structures employed in this method are identical to those described in the previous embodiments, and thus will not be repeated here.

Referring to FIGS. 6, and 7A to 7E, the method for connecting the battery to the battery terminal connector or the terminal module comprises the following steps:
a. obliquely inserting a conductive side of the battery 11 into the battery slot 10 from an upper right hand side towards a side below (as indicated in FIG. 7A);
b. continually inserting the battery 11 into the battery slot 10 obliquely until the battery runs into the contact head 20 of the L-shaped buffering portion 2 (as indicated in FIG. 7C);
c. horizontally moving the battery 11, wherein the battery is obliquely inserted into the battery slot 10 from the upper right hand side towards a side below, and the battery 11 pushes aside the contact head 20 and comes into contact with the elastic terminal 15, and the contact head 20 may be tilted forwards (as indicated in FIG. 7B) or backwards (as indicated in FIG. 7D);
d. keeping moving the battery 11 horizontally so as to allow the battery 11 to keep pushing against the contact head 20 and the elastic terminal 15, so that the L-shaped buffering portion 2 is fixingly tilted towards a direction where the battery 11 is moving into (as indicated in FIG. 7D); and
e. stopping moving the battery 11 once the battery 11 is completely placed into the battery slot 10, so that the battery 11 is retained via a reverse force of the L-shaped buffering portion 2, and thus the battery 11 may come into contact with the elastic terminal 15 stably (as indicated in FIG. 7E).

Because the vertical part 21 of the L-shaped buffering portion 2 is made from stiff materials that are slightly flexible. When it is impacted by the battery 11, the L-shaped buffering portion 2 tilts forwards or backwards according to directions of the impact force with the fulcrum 130 as its pivot point. When no battery is inserted in the battery slot 10, the length of the contact head 20 of the L-shaped buffering portion 2 protruding outwards is greater than that of the elastic terminal 15 extending out of the terminal socket 14. Therefore, when impacts are born upon the battery terminal connector 1, the contact head 20 may bear and ease direct impacts from the battery 11, thus lessening impacts born upon each of the elastic terminals 15 and protecting the elastic terminals 15 from being damaged.

FIG. 6 shows a variation of the method according to the fourth preferred embodiment of the invention, in which the battery terminal connector 1 or the terminal module 1′ has a continuous or discontinuous block wall 131, or one or a plurality of block strips 131′ integrally formed with the basement of insulator body 13 and between two neighboring terminal sockets 14, which are also a distance away from the battery. The thickness of the block wall 131 or the block strip 131′ is determined by precise calculations, and may provide a reverse force that compensates for the tilting of the L-shaped buffering portion 2, so as to prevent the L-shaped buffering portion 2 from tilting excessively. Therefore, the distance which the elastic terminal 15 is pushed away by the battery may be controlled, which effectively protects the elastic terminal 15 from being pushed excessively and damaged, as well as preventing the L-shaped buffering portion 2 from tilting backwards excessively and getting fractured consequently.

### The Fifth Preferred Embodiment

Furthermore, real-life situations for inserting the battery is also considered in the invention, in which the battery may not only be inserted from the upper right hand side towards a side below, but also from an upper left hand side to towards a side below. As a result, a fifth preferred embodiment of the invention is also proposed, in order to describe a method for connecting the battery to the battery terminal connector or the terminal module from the upper left hand side towards a side below into the battery slot.

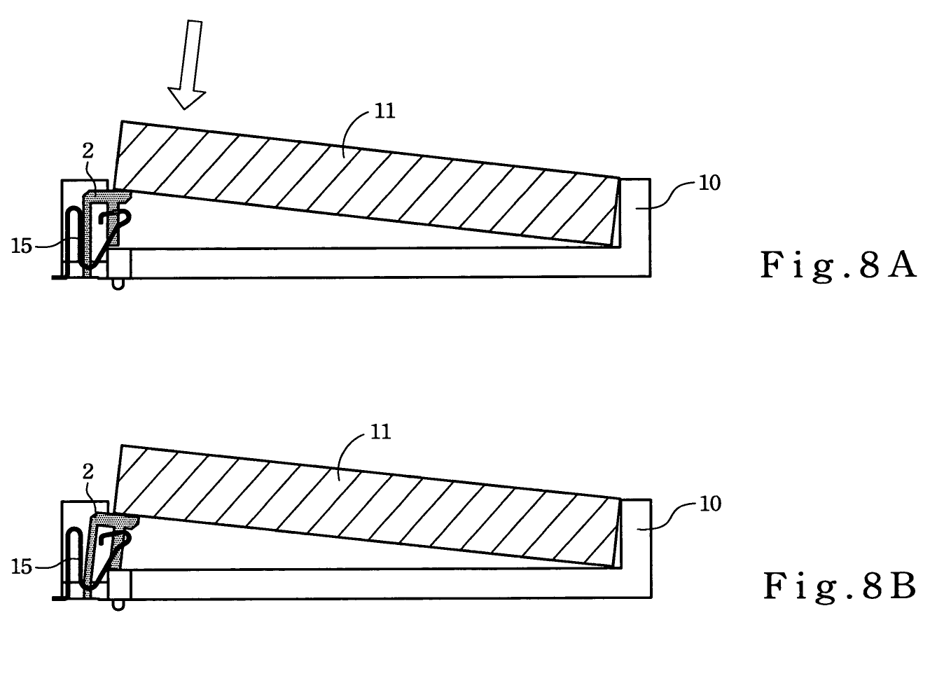

Referring to FIGS. 8A to 8B, the method for connecting the battery to the battery terminal connector or the terminal module comprises the following steps:
a. obliquely inserting a conductive side of the battery 11 into the battery slot 10 from the upper left hand side towards a side below;
b. continually inserting the battery 11 into the battery slot 10 obliquely until the battery 11 runs into the contact head 20 of the L-shaped buffering portion 2 (as indicated in FIG. 8A);
c. horizontally moving the battery 11, the L-shaped buffering portion 2 is tilted forwards from the impacts of the battery coming from the upper left hand side, which prevents the elastic terminal 15 from directly contacting the battery 11 and protecting the elastic terminal 15 from the impacts, and when the battery is obliquely inserted into the battery slot 10 from the upper left hand side towards a side below the structure of fool-proof 12 around the battery slot 10 (as shown in FIG. 3) prevents the battery from advancing further, which reminds users of re-inserting the battery correctly, followed by steps identical to those described in the previous embodiment;
d. keeping moving the battery 11 horizontally so as to allow the battery 11 to keep pushing against the contact head 20 and the elastic terminal 15, so that the L-shaped buffering portion 2 is fixingly tilted towards a direction where the battery 11 is moving into; and
e. stopping moving the battery 11 once the battery 11 is completely placed into the battery slot 10, so that the battery 11 is retained via a reverse force of the L-shaped buffering portion 2, and thus the battery may come into contact with the elastic terminal 15 stably.

Because the vertical part 21 of the L-shaped buffering portion 2 is made from stiff materials that are slightly flexible, when it is impacted by the battery 11, the L-shaped buffering portion 2 tilts forwards or backwards according to directions of the impact force with the fulcrum 130 as its pivot point. When no battery is inserted in the battery slot 10, the length of the contact head 20 of the L-shaped buffering portion 2 protruding outwards is greater than that of the elastic terminal 15 extending out of the terminal socket 14. Therefore, when impacts are born upon the battery terminal connector 1, the contact head 20 may bear and ease direct impacts from the battery 11, thus lessening impacts born upon each of the elastic terminals 15 and protecting the elastic terminals 15 from being damaged.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. A battery terminal connector being disposed in a battery slot of an electronic device, so as to induce electrical conduction from contacting a battery, and a structure of fool-proof is formed around the battery slot in order to guide users to insert the battery along a particular direction into the battery slot, wherein the battery terminal connector comprises a basement of insulator body, a plurality of terminal sockets integrally extended from the basement of insulator body and protruded in parallel to each other, and a plurality of elastic terminals, and at least a portion of each of the elastic terminals extends out of each terminal socket, and the battery terminal connector is characterized in that:
at least an L-shaped buffering portion integrally molded with the basement of insulator body is formed between two neighboring terminal sockets, and the L-shaped buffering portion may be fixingly tilted under an external force, and an end of the L-shaped buffering portion facing the battery is formed into an contact head protruding outwardly, and when no battery is inserted in the battery slot, a length of the contact head of the L-shaped buffering portion that protrudes outwards is greater than that of each elastic terminal extending out of each terminal socket, so that when impacts are born upon the battery terminal connector from the battery, the impacts are firstly buffered by the contact head, thus reducing the impacts born upon each of the elastic terminals from the battery.

2. The battery terminal connector of claim 1, wherein the L-shaped buffering portion further comprises an integrally formed vertical part and an integrally formed horizontal part, and the vertical part extends upwards from the basement of insulator body, and has a fulcrum formed at an end thereof near the basement of insulator body, and the horizontal part extends horizontally from an end of the vertical part away from the fulcrum, and the horizontal part extends out of the terminal socket and connects to the contact head.

3. The battery terminal connector of claim 2, wherein the horizontal part has an interfering stick integrally and downwardly extended from a bottom part thereof near the contact head, and a length of the interfering stick is smaller than a vertical length of the vertical part.

4. The battery terminal connector of claim 1, wherein materials for making the L-shaped buffering portion may be selected from the group consisting of elastic plastics, expandable metals, flexible metal alloys, and elastic insulating resins.

5. The battery terminal connector of claim 1, wherein the contact head tapers gradually from bottom to top, and a front end of the contact head that contacts the battery has a blocking plane formed thereon for guiding the L-shaped buffering portion to tilt away from the contact head.

6. The battery terminal connector of claim 1, wherein the basement of insulator body has a continuous block wall integrally formed thereon between two neighboring terminal sockets for preventing the L-shaped buffering portion from tilting excessively.

7. The battery terminal connector of claim 1, wherein the basement of insulator body has at least a block strip integrally formed thereon between two neighboring terminal sockets for preventing the L-shaped buffering portion from tilting excessively.

8. A terminal module for contacting batteries of digital and electronic products and inducing electrical conduction from contacting the batteries, wherein the terminal module comprises a basement of insulator body, a plurality of terminal sockets integrally extended from the basement of insulator body and protruded in parallel to each other, and a plurality of elastic terminals, and at least a portion of each of the elastic terminals extends out of each terminal socket, and the terminal module is characterized in that:
at least an L-shaped buffering portion integrally molded with the basement of insulator body is formed between two neighboring terminal sockets, and the L-shaped buffering portion may be fixingly tilted under an external force, and an end of the L-shaped buffering portion facing the batteries is formed into an contact head protruding outwardly, and before batteries come into contact with the terminal module, a length of the contact head of the L-shaped buffering portion that protrudes outwards is greater than a length of each elastic terminal outside of each terminal socket, so that when impacts are born upon the terminal module from the batteries, the impacts are firstly buffered by the contact head, thus reducing the impacts born upon each of the elastic terminals from the batteries.

9. The terminal module of claim 8, wherein the L-shaped buffering portion further comprises an integrally formed vertical part and an integrally formed horizontal part, and the vertical part extends upwards from the basement of insulator body, and has a fulcrum formed at an end thereof near the basement of insulator body, and the horizontal part extends horizontally from an end of the vertical part away from the fulcrum, and the horizontal part extends out of the terminal socket and connects to the contact head.

10. The terminal module of claim 9, wherein the horizontal part has an interfering stick integrally and downwardly extended from a bottom part thereof near the contact head, and a length of the interfering stick is smaller than a vertical length of the vertical part.

11. The terminal module of claim 8, wherein materials for making the L-shaped buffering portion may be selected from the group consisting of elastic plastics, expandable metals, flexible metal alloys, and elastic insulating resins.

12. The terminal module of claim 8, wherein the contact head tapers gradually from bottom to top, and a front end of the contact head that contacts the batteries has a blocking plane formed thereon for guiding the L-shaped buffering portion to tilt away from the contact head.

13. The terminal module of claim 8, wherein the basement of insulator body has a continuous block wall integrally formed thereon between two neighboring terminal sockets for preventing the L-shaped buffering portion from tilting excessively.

14. The terminal module of claim 8, wherein the basement of insulator body has at least a block strip integrally formed thereon between two neighboring terminal sockets for preventing the L-shaped buffering portion from tilting excessively.

15. A portable communicating device comprising at least a battery and a battery slot for receiving the battery, and a structure of fool-proof is formed around the battery slot in order to guide users to insert the battery along a particular direction into the battery slot, and the battery slot has at least a row of terminal modules formed therein so as to induce electrical conduction from contacting the battery; wherein each of the terminal modules comprises a basement of insulator body, a plurality of terminal sockets integrally extended from the basement of insulator body and protruded in parallel to each other, and a plurality of elastic terminals, and at least a portion of each of the elastic terminals extends out of each terminal socket, and the terminal module is characterized in that:
at least an L-shaped buffering portion integrally molded with the basement of insulator body is formed between two neighboring terminal sockets, and the L-shaped buffering portion may be fixingly tilted under an external force, and an end of the L-shaped buffering portion facing the battery is formed into an contact head protruding outwardly, and when no battery is inserted in the battery slot, a length of the contact head of the L-shaped buffering portion that protrudes outwards is greater than a length of each elastic terminal outside of each terminal socket, so that when impacts are born upon the terminal module from the battery, the impacts are firstly buffered by the contact head, thus reducing the impacts born upon each of the elastic terminals from the battery.

16. The portable communicating device of claim 15, wherein the L-shaped buffering portion further comprises an integrally formed vertical part and an integrally formed horizontal part, and the vertical part extends upwards from the basement of insulator body, and has a fulcrum formed at an end thereof near the basement of insulator body; the horizontal part extends horizontally from an end of the vertical part away from the fulcrum, and the horizontal part extends out of the terminal socket and connects to the contact head.

17. The portable communicating device of claim 16, wherein the horizontal part has an interfering stick integrally and downwardly extended from a bottom part thereof near the contact head, and a length of the interfering stick is smaller than a vertical length of the vertical part.

18. The portable communicating device of claim 15, wherein the contact head tapers gradually from bottom to top, and a front end of the contact head that contacts the battery has a blocking plane formed thereon for guiding the L-shaped buffering portion to tilt away from the contact head.

19. A method for connecting a battery to the battery terminal connector, the battery terminal connector is disposed inside of a battery slot of an electronic device so as to induce electrical conduction via contacting the battery, wherein the battery terminal connector comprises a basement of insulator body, a plurality of terminal sockets, and a plurality of elastic terminals; at least an L-shaped buffering portion integrally molded with the basement of insulator body is formed between two neighboring terminal sockets, and an end of the L-shaped buffering portion facing the battery is formed into an outwardly protruded contact head; the method for connecting the battery to the battery terminal connector comprises the following steps:
obliquely inserting a conductive side of the battery into the battery slot from an upper side towards a side below;
continually inserting the battery into the battery slot from an upper right hand side towards a side below until the battery runs into the contact head of the L-shaped buffering portion;
horizontally moving the battery so as to allow the battery to push aside the contact head and come into contact with the elastic terminal;
keeping moving the battery horizontally so as to allow the battery to keep pushing against the contact head and the elastic terminal, so that the L-shaped buffering portion is fixingly tilted towards a direction where the battery is moving into; and
stopping moving the battery once the battery is placed into the battery slot, so that the battery is retained via a reverse force of the L-shaped buffering portion, and thus the battery may come into contact with the elastic terminal stably.

20. The method of claim 19, wherein the battery is obliquely inserted into the battery slot from an upper right hand side towards a side below.

21. The method of claim 19, wherein the battery is obliquely inserted into the battery slot from an upper left hand side towards a side below.

22. A method for connecting a battery to the terminal module, the terminal module comprises a basement of insulator body, a plurality of terminal sockets, and a plurality of elastic terminals; at least an L-shaped buffering portion integrally molded with the basement of insulator body is formed between two neighboring terminal sockets, and an end of the L-shaped buffering portion facing the battery is formed into an outwardly protruded contact head; the method for connecting the battery to the terminal module comprises:
obliquely inserting a conductive side of the battery into the battery slot from an upper side towards a side below;
continually inserting the battery into the battery slot from an upper side towards a side below until the battery runs into the contact head of the L-shaped buffering portion;
horizontally moving the battery so as to allow the battery to push aside the contact head and come into contact with the elastic terminal;
keeping moving the battery horizontally so as to allow the battery to keep pushing against the contact head and the elastic terminal, so that the L-shaped buffering portion is fixingly tilted towards a direction where the battery is moving into; and
stopping moving the battery once the battery is placed into the battery slot, so that the battery is retained via a reverse force of the L-shaped buffering portion, and thus the battery may come into contact with the elastic terminal stably.

23. The method of claim 22, wherein the battery is obliquely inserted into the battery slot from an upper right hand side towards a side below.

24. The method of claim 22, wherein the battery is obliquely inserted into the battery slot from an upper left hand side towards a side below.
